(19) United States
(12) Patent Application Publication
(10) Pub. No.: US 2010/0148696 A1
(43) Pub. Date: Jun. 17, 2010

(54) METHOD FOR CONTROLLING THE EMISSION BEHAVIOR OF LUMINAIRES IN AN ARRANGEMENT OF A PLURALITY OF LUMINAIRES, AND AN ARRANGEMENT OF A PLURALITY OF LUMINAIRES

(75) Inventor: Wolfgang Pabst, Deisenhofen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/636,802

(22) Filed: Dec. 14, 2009

(30) Foreign Application Priority Data
Dec. 17, 2008 (DE) 10 2008 062 674.0

(51) Int. Cl. H05B 37/02; H05B 39/00

(52) U.S. Cl. 315/294; 315/312

(57) ABSTRACT

A method for controlling the emission behavior of luminaires in an arrangement of a plurality of luminaires is provided. The method may include using a first luminaire of the plurality of luminaires to define the desired emission behavior at least of itself and at least of one further luminaire; emitting light by means of the first luminaire, to which signals are applied that transmit at least one information item relating to the desired emission behavior; and receiving the light by means of at least one second luminaire, reading out the at least one information item, and emitting light in accordance with the at least one information item.

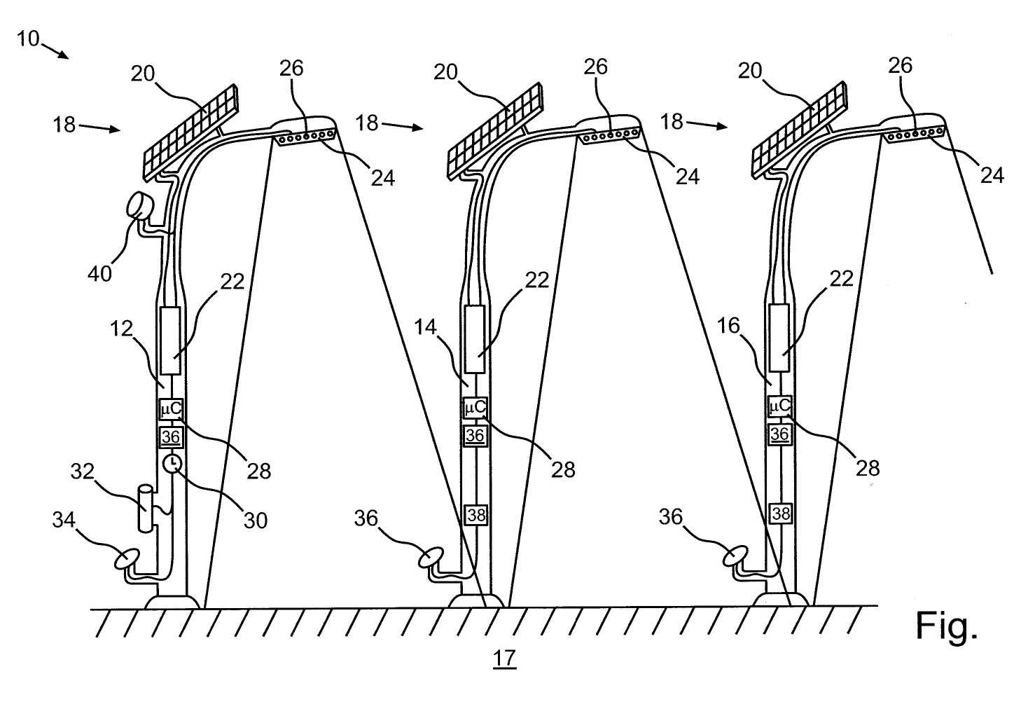

### CROSS-REFERENCE TO RELATED APPLICATION

This application claims priority to German Patent Application Serial No. 10 2008 062 674.0, which was filed Dec. 17, 2008, and is incorporated herein by reference in its entirety.

### TECHNICAL FIELD

Various embodiments relate to a method for controlling the emission behavior of luminaires in an arrangement of a plurality of luminaires. Various embodiments also relate to an arrangement of a plurality of luminaires.

### BACKGROUND

What is intended, by way of example, is an extensive distribution of a number of luminaires specifically, for example, of street luminaires that are arranged one after another along a street.

For many years, street luminaires have been connected to an electricity supply system and have been turned on and off under central control. As in publication DD 44788 (Wiegand), for example, there is an increasing trend to decentralizing the control of such street luminaires. Street luminaires can, for example, be combined street by street to form closed systems. Such systems are disclosed, for example, in publications DE 102006058 (Sobottka) and U.S. Pat. No. 4,841,278 (Tezuka). Use is made there of radio or infrared signals for transmitting information. The emission behavior is defined for each system individually. Particularly in remote areas, it is not necessary for the street luminaires to shine continuously on all streets. Thus, it may suffice to illuminate a main thoroughfare, and to illuminate streets branching off therefrom whenever humans are moving in the street.

There has also been a trend to supplying street luminaires with current in a dentralized fashion. In particular there are street luminaires that are equipped with a dedicated solar module such as are described, for example, in publication U.S. Pat. No. 6,784,357 (Wang): during the day, the solar module is used to obtain electrical energy that is stored in a battery. When darkness falls, use is made of the energy from the battery in order to make the street luminaires shine. In the case of these systems, it is particularly desirable not to output too much of the energy stored in the battery during operation, so that a sufficient reserve of energy is available for the case in which poor weather prevails for some time and no new electrical energy can be obtained from sunlight.

DE 202008004790 describes an exterior luminaire that sets its emission characteristic automatically to weather conditions.

Document EP 1860800 (Nakagawa) describes making simultaneous use of the light emitted by LED luminaires also to transmit data to road users by the application of signals, the data being transmitted between the luminaires with the aid of transmitters/receivers of an optical data transmission system.

### SUMMARY

A method for controlling the emission behavior of luminaires in an arrangement of a plurality of luminaires is provided. The method may include using a first luminaire of the plurality of luminaires to define the desired emission behavior at least of itself and at least of one further luminaire; emitting light by means of the first luminaire, to which signals are applied that transmit at least one information item relating to the desired emission behavior; and receiving the light by means of at least one second luminaire, reading out the at least one information item, and emitting light in accordance with the at least one information item.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which the sole FIGURE shows an arrangement of a plurality of luminaires in accordance with an embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Since street luminaires that are equipped with a solar module need no longer be connected to a current lead supplied from a power station it would be desirable if it were also possible to dispense with signal lines via which the street luminaires are controlled. It would then be possible to set up the street luminaires independently of wiring systems.

Various embodiments indicate a way in which the emission behavior of luminaires in an arrangement of a plurality of luminaires can be controlled inexpensively.

The FIGURE shows an arrangement of luminaires 12, 14 and 16 that is denoted as a whole by 10.

The luminaires 12, 14 and 16 are fastened on the ground 17. There are no cables running in the ground 17, neither power cables nor signal lines. The power supply of the luminaires 12, 14 and 16 is performed via solar modules 18 that include or consist of an arrangement 20 of solar cells and an accumulator 22, coupled thereto, for storing electrical energy. The actual light source 24, which includes or consists in this case of a plurality of light emitting diodes 26, is supplied with power from the accumulator 22. Each of the luminaires 12, 14 and 16 has a microprocessor 28 that is likewise supplied with current from the accumulator 22.

The light emission behavior of the luminaires 12, 14 and 16 is to take place in a coordinated fashion. It is defined in the present case by the first luminaire 12, e.g. by the use of a program running in the microprocessor 28 of the first luminaire 12.

The microprocessor 28 is coupled to a clock 30. It is also coupled to a movement detector 32. Finally, it is also coupled to a photosensitive sensor 34 that is to be designed in the present case as a dusk sensor.

Stored in a memory 36 assigned to the microprocessor 28 of the first luminaire is a table of the times of day at which the luminaires 12, 14 and 16 are to be switched on. It can also be provided that at specific times of day there is a readiness to switch on the luminaires 12, 14 and 16, but that there is a need to fulfill a further condition in order to prompt the actual switching on. Thus, for example, there can be a readiness to switch on during the later afternoon hours, and the luminaires 12, 14 and 16 can actually be prompted to switch on when the dusk sensor 34 establishes that a predetermined degree of darkness has already been reached, for example because the sky is very cloudy. It can likewise be provided in the night hours that the luminaires 12, 14 and 16 are not switched on, but that the luminaires 12, 14 and 16 of the arrangement 10 are switched on when a movement is detected by the movement detector 32.

Switching on is now performed as follows: the microprocessor 28 of the first luminaire 12 causes the light source 24 to be switched on. Initially, the microprocessor 28 can switch on only the light source 24 of the first luminaire 12. However, light is output at a high frequency that cannot be resolved by the human eye, in the range of a few megahertz, in this case. To the human observer, the luminaire 12 is outputting light uniformly, but actually there are changes in light intensity at high frequency. Information items are transmitted via these changes in intensity. The second luminaire 14 has a light sensor 36 that detects the light emanating from the first luminaire 12. A downstream evaluation unit, e.g. an evaluation circuit, 38 evaluates the signals in the light. These signals are passed onto a microprocessor 28 of the luminaire 14 that likewise causes the light source 24 of the luminaire 14 to shine. This takes place as a function of the information items determined. The information items can, by way of example, also define the entire, temporally averaged light intensity that is output by the light source 24 of the second luminaire 14. The microprocessor 28 of the second luminaire 14 is also designed such that it can pass on information items via the light emitted by the light source 24, that is to say can control the light emitting diodes 26 in a pulsed fashion. What can be involved here in the simplest case is precisely those information items that have been transmitted by the first luminaire 12, but the microprocessor 28 of the second luminaire 14 can also condition these information items, for example on the basis of data that are stored in a memory 36 assigned to it.

Finally, the light emitted by the light source 24 of the second luminaire 14 passes to a light sensor 36 of the third luminaire 16, and what happened in the second luminaire 14 happens there, specifically the light source 24 is prompted to shine.

The arrangement 10 can, by way of example, form a chain of which the first luminaire 12 is the first element. The respective last element of the chain need not necessarily pass on information items. Also conceivable are branched structures in which one luminaire, for example the first luminaire, outputs light signals to exactly two further luminaires. It is equally possible as well in each case for two luminaires to operate in a coordinated fashion: for example two luminaires can be arranged on mutually opposite sides of a street, and, again, two luminaires can be arranged further on at mutually opposite points. If the street has a curved course therebetween, it is not uniquely defined from which of the first pair of the luminaires light passes to which of the second pair of the luminaires. Consequently, the luminaires can pass on the signal in a fashion coordinated in pairs. The coordination need not be effected by separate tuning signals, but can be performed automatically owing to predetermination of the time sequence.

In the FIGURE, the luminaire lying respectively further to the left outputs light signals to the luminaire respectively lying further to the right. In principle, the light cones of two adjacent luminaires can overlap one another such that it is, by way of example, also possible for the signals to be transmitted in two opposite directions. Light sensors are then to be arranged correspondingly. For example, the signal transmission can be blocked in a chain because of a defect in one of the luminaires. It is then sensible if the first luminaire is informed of the failure of one of the luminaires by signals in the return direction.

The first luminaire 12 is provided with a radio transmitting and receiving unit 40, e.g. a receiver, that is coupled to the microprocessor 28 and serves to provide communication between the first luminaire and an external system that is not shown in the FIGURE. Control commands can be given via the external system to the first luminaire, which is taken into account, if appropriate in addition to the signals from the clock, the motion detector 32 and the dusk sensor 34 in outputting light and, in particular, light signals. Conversely, information items can be transmitted via the transmitting and receiving unit 40 from the first luminaire 12 to the power station. It is possible in principle for the first luminaire 12 also to be connected to a power station via cables, in which case the transmitting and receiving unit 40 can be omitted. However, the further luminaires 14 and 16 then do not require a cable connection.

The photosensitive sensor 34 need not be, or need not only be, sensitive to light in the visible region, but can also be designed to detect light in the adjacent frequency regions (infrared, ultraviolet).

Various embodiments encompass the use of a first one of the luminaires to define the desired emission behavior of itself, and at least of one further luminaire. The first luminaire emits light to which signals are applied via which at least one information item relating to the desired emission behavior is transmitted. Signals are typically applied to light by temporal variation of the light intensity. The light is received by a second luminaire, and the latter reads out the at least one information item from the signals and emits light in accordance with at least one information item from the information items read out.

Consequently, the first luminaire may define the desired emission behavior at least of a second luminaire, and the latter receives appropriate instructions and implements them. Separate signal lines, e.g., are thereby dispensed with. There is no need to go to the expense of providing suitable radio links or infrared links between the luminaires and to equip the luminaires individually with transmitters and receivers for this purpose. Rather, the light source itself is used as transmitter, and so the outlay involved is particularly low.

The second luminaire may equally emit light to which signals are applied. It can likewise transmit an information item via these signals. The communication link is therefore extended.

This can take place in a further direction, or back to the first luminaire.

Thus, the signals in the light emitted by the second luminaire can be used to transmit at least one information item relating to the desired emission behavior to a further (third) luminaire. Since the first of the luminaires has defined the desired emission behavior, this information item may be selected from the information items read out. However, it is also possible for the second luminaire to be provided with devices that enable a correction of the desired emission behavior defined by the first luminaire by means of the second luminaire such that the information items passed on are conditioned information items, although on the basis of the information items read out.

The second luminaire can also transmit to the first luminaire an information item relating to a fact opposing the emission behavior in accordance with the desired emission behavior. For example, it can be that the second luminaire has a malfunction and communicates this to the first luminaire. For example, it is also possible for a further luminaire to have a malfunction, and this information item relating to the malfunction of the further luminaire can be transmitted to the first luminaire in the opposite direction to the transmission of the information item referring to the desired emission behavior.

The emission behavior of the luminaires may be coordinated by a method according to various embodiments. Consequently, there is no longer any need to process in the individual luminaires information items from which the desired emission behavior can be derived, rather this is necessary only for the first luminaire. The definition of the desired emission behavior by means of the first luminaire can, by way of example, be performed as a function of the time of day: a suitable data processing unit, for example a microprocessor, in the first luminaire can have a stored table defining at which time of day on which day of the year the luminaire is to be switched on, and at which time of day the luminaire is to be switched off. Alternatively, the first luminaire can also detect the light intensity in the surroundings and be equipped for this purpose with a suitable dusk sensor. It is detected when darkness has fallen to a specific degree, and then the luminaire is prompted to be switched on. The detected light intensity can also be considered in combination with the time of day during the definition. Thus, for example, in the case of temporary darkness during the day it is possible to refrain from switching on the luminaire or to wait to see whether such darkness lasts over a predetermined time period. Alternatively, or in addition to the time of day and to the light intensity detected, it is also possible to consider signals of a movement detector when defining the desired emission behavior. This is expedient, for example, whenever the first luminaire is stationed at the entrance of a street: if it detects a movement, it is possible to prompt all the luminaires from the street to be switched on. The luminaires need not then be switched on continuously, but can be brought to switch on when required. A passer-by or a motor vehicle causes switching on when the respective street is entered by a pedestrian or driven into.

It may be provided to be impossible for the human eye to detect that signals are being transmitted by the light of the luminaires. The human eye is no longer possible of resolving frequencies over 100 Hz. The change in intensity of the light is oriented thereto. Said change need not occur in fixed frequencies, but the time scales over which the change in intensity occurs are to correspond to periods of oscillation of an oscillation with a frequency of more than 100 Hz, e.g. more than 20 kHz. For example, LEDs whose intensity is variable at frequencies in the MHz range can be used as light sources.

In the case of the arrangement in accordance with various embodiments, a first luminaire is configured to output light to which signals are applied, and a second luminaire is configured to receive such light, to read out information contained in the signals, and to output light in accordance with such information.

It may be pointed out that at least two luminaires output light in the present case. The transmission of signals via light is known per se. It is not known for a light source to be used for its own purpose, specifically illumination, while simultaneously serving as a signal source, and that communication with a second light source is effected.

One of the luminaires may be configured both to output light to which signals are applied and to receive such light, to read out information contained in the signals, and to output light in accordance with the information. A further, that is to say third luminaire can also be involved here. The luminaire with these properties can, however, also be the first luminaire or the second luminaire.

The first luminaire may include a clock, a dusk sensor and/or a motion detector, and it may include a data processing device that serves to process signals produced by these devices in order to define signals that are applied to the light.

The luminaires that are designed to receive light to which signals are applied typically have a light sensor for this purpose. The latter should be aligned such that it receives light from at least one other of the luminaires, for example that luminaire from which signals are expected. If the luminaires of the arrangement are arranged in a type of chain, the light sensor can be oriented toward the preceding luminaire from the chain, whereas the light source can be oriented in the direction of the subsequent luminaire in the chain. However, so that it is possible to communicate in two directions, for example to transmit fault alarms to the first luminaire, it is also possible to provide that the light sources shine in a direction toward two luminaires, specifically toward the preceding luminaire in the chain and toward the subsequent luminaire in the chain, and the light sensors can receive light from these two luminaires. If appropriate, however, two separate light sensors can be provided.

Since the arrangement in accordance with various embodiments may have no need of any signal line interconnecting the luminaires, it may be particularly sensible to dispense with current leads, as well. To this end, each luminaire can include a power supply unit that provides the entire current for the luminaire. A solar module may be used as power supply unit, while other power supply units are also possible. The luminaires can then be set up independently of ground wire systems, and so there is increased freedom in the selection of places for the luminaires.

It is possible to dispense with other types of transmitters and associated receivers for respectively transmitting and receiving wirelessly transmitted signals owing to the fact that the luminaires intercommunicate via the light that they output in any case. If necessary, a luminaire, in particular the first luminaire, can have such transmitters or receivers, not for the purpose of communicating with the other luminaires, however, but in order to receive signals from an external control unit. Such signals can then be used by the first luminaire in order to define the desired emission behavior of all the luminaires, if appropriate additionally as a function of signals from the clock, the dusk sensor and/or the motion detector.

It is particularly easy to transmit signals via the light emitted by the luminaires when the luminaires have light emitting diodes as light sources, because the light emission thereof can be modulated with frequencies in the megahertz range.

It is also possible to apply various embodiments to luminaires arranged in two or three dimensions. For example, luminaires can be arranged in rows and columns on the ceiling in an illumination system for a hall or an office room. The light to which signals are applied is transmitted to a plurality of adjacent luminaires by a master luminaire. The adjacent luminaires, which are denoted as slave luminaires, set their emission behavior in accordance with the received signals, and in turn modulate their emitted light in accordance with the received information items. Thus, a desired variation in the emission behavior can be spread quickly over an entire illumination system with many luminaires. The master luminaire is advantageously centrally situated such that it can control at least four adjacent luminaires in a first transmission. The desired variation in the emission behavior continues beginning from the middle of the illuminated space as far as the edges thereof.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for controlling the emission behavior of luminaires in an arrangement of a plurality of luminaires, the method comprising:
using a first luminaire of the plurality of luminaires to define the desired emission behavior at least of itself and at least of one further luminaire;
emitting light by means of the first luminaire, to which signals are applied that transmit at least one information item relating to the desired emission behavior; and
receiving the light by means of at least one second luminaire, reading out the at least one information item, and emitting light in accordance with the at least one information item.

2. The method as claimed in claim 1,
wherein the second luminaire emits light to which signals are applied, at least one information item being transmitted via the signals.

3. The method as claimed in claim 2,
wherein at least one information item relating to the desired emission behavior is transmitted to a further luminaire by means of the signals in the light emitted by the second luminaire, the at least one information item transmitted to the further luminaire.

4. The method as claimed in claim 3,
wherein the further luminaire is contained in the read out information items.

5. The method as claimed in claim 2,
wherein at least one information item relating to a fact opposing an emission behavior in accordance with the desired emission behavior is transmitted to the first luminaire by means of the signals in the light emitted by the second luminaire.

6. The method as claimed in claim 1,
wherein the definition of the desired emission behavior is performed as a function of at least one of a time of a day; of a light intensity detected by the first luminaire in its surroundings; of signals of a movement detector; and of externally received signals.

7. The method as claimed in claim 1,
wherein the signals occur by means of temporally variable changing of the light intensity on time scales defined by frequencies of more than 100 Hz.

8. The method as claimed in claim 7,
wherein the signals occur by means of temporally variable changing of the light intensity on time scales defined by frequencies of more than 20 kHz.

9. The method as claimed in claim 1, further comprising:
receiving the light by means of a number of adjacent luminaires;
reading out the at least one information item; and
emitting light in accordance with the at least one information item.

10. An arrangement, comprising:
a plurality of luminaires,
wherein a first luminaire of the plurality of luminaires is configured to define the desired emission behavior at least of itself and of a further luminaire and to output light to which signals are applied that can transmit at least one information item relating to the desired emission behavior; and
wherein a second luminaire is configured to receive such light, to read out information contained in the signals, and to output light in accordance with such information.

11. The arrangement as claimed in claim 10,
wherein a luminaire is configured both to output light to which signals are applied, and to receive such light, to read out information contained in the signals, and to output light in accordance with such information.

12. The arrangement as claimed in claim 10,
wherein the first luminaire comprises at least one of a clock; a dusk sensor; a motion detector; a transmitter; and a receiver; and
wherein the first luminaire comprises a data processing device for processing signals produced by these device in order to define the signals that are applied to the light.

13. The arrangement as claimed in claim 10,
wherein the second luminaire comprises a light sensor that is aligned such that it receives light from another luminaire of the plurality of luminaires.

14. The arrangement as claimed in claim 13,
wherein the a further luminaire comprises a light sensor that is aligned such that it receives light from another luminaire of the plurality of luminaires.

15. The arrangement as claimed in claim 10,
wherein at least a portion of the luminaires is configured to draw current exclusively from a power supply unit belonging to the luminaire.

16. The arrangement as claimed in claim 15,
wherein each luminaire is configured to draw current exclusively from the power supply unit belonging to the luminaire.

17. The arrangement as claimed in claim 15,
wherein the power supply unit comprises a solar module belonging to the luminaire.

18. The arrangement as claimed in claim 10,
wherein at most one luminaire comprises at least one of a transmitter for transmitting; and a receiver for receiving wirelessly transmitted signals differing from light signals.

19. The arrangement as claimed in claim 10,
wherein at least one of the plurality of luminaires comprises at least one light emitting diode as a light source.

20. The arrangement as claimed in claim 10,
wherein the luminaires are arranged in at least one of two dimensions and three dimensions relative to one another; and
wherein at least two adjacent luminaires are configured to receive light to which signals are applied, and to read out information contained in the signals, and to output light in accordance with such information.
